(19) United States
(12) Patent Application Publication
(10) Pub. No.: US 2020/0387168 A1
(43) Pub. Date: Dec. 10, 2020

(54) Automated Convoy Assembly in Tactical Assembly Area

(71) Applicants: Alberto Daniel Lacaze, Potomac, MD (US); Karl Nicholas Murphy, Rockville, MD (US)

(72) Inventors: Alberto Daniel Lacaze, Potomac, MD (US); Karl Nicholas Murphy, Rockville, MD (US)

(73) Assignee: Mr,.Alberto Daniel Lacaze, Gaithersburg, MD (US)

(21) Appl. No.: 16/430,577

(22) Filed: Jun. 4, 2019

(51) Int. Cl. G05D 1/02

(52) U.S. Cl. CPC G05D 1/0293; G05D 1/0214; G05D 2201/0213; G05D 1/0289; G05D 1/0217

(57) ABSTRACT

A system has been developed for arranging a number of autonomous vehicles at a staging area which comprises two or more autonomous vehicles, a localization mechanism that provides the relative or absolute position of the autonomous vehicle to be arranged, a pattern for aligning the autonomous vehicles at the staging area and a planning algorithm that takes as input the current state of the autonomous vehicles and creates obstacle free trajectories that optimize the motion from the current state to a formation that matches the desired pattern. A set of operator aids have been created for automated convoy assembly in tactical assembly area. These aids can be remote and do not need to be in the same cab of the vehicle. The operator aids are used in conjunction with full automation. The operator is allowed to decide where to form the convoy and where to align. Also, if the operator decides where the convoy is to be placed, then the process of positioning the vehicles to follow the poses provided by the operator is a subset of the tasks necessary to perform alignment of the PLS with the trailer for the loading and unloading maneuvers. Multivehicle deconfliction is performed allowing for all vehicles to move to the desired location in parallel. The sensors on one vehicle will be used to aid the maneuvers of other vehicles. The multivehicle optimization takes under consideration the sensor footprint to organize the movements and reduce the areas where the vehicles would be performing maneuvers blindly. Multivehicle world model representation is performed where sensor suites from all vehicles are used to create a common representation. The operator aids are migrated to select the pose of the assembled convoy. Optimization algorithm is migrated to solve the multivehicle trajectory generation that deconflicts collisions, simultaneously moves all vehicles to the desired pose, and optimizes sensor placement in which trucks help each other into position.

### CROSS-REFERENCES TO RELATED APPLICATIONS

Not applicable.

### BACKGROUND OF THE INVENTION

### 1. Field of the Invention

The present invention describes a system for arranging a number of autonomous vehicles at a staging area comprising two or more autonomous vehicles, a localization mechanism that provides the relative or absolute position of the vehicle to be arranged, a pattern for aligning the vehicles at the staging area, and a planning algorithm that can take as input the current state of the vehicles and create obstacle free trajectories that optimize the motion from this current state to a formation that matches the desired pattern. It also involves the creation of a set of operator aids for automated convoy assembly in tactical assembly area and these aids can be remote and do not have to be in the same cab of the vehicle. The operator aids are used in conjunction with full automation. The operator is allowed to decide where to form the convoy and where to align and also decides where the convoy is to be placed. Then the process of positioning the vehicles to follow the poses provided by the operator is a subset of the tasks necessary to perform alignment of the PLS with the trailer for the loading and unloading maneuvers. Multivehicle deconfliction is conducted allowing for all the vehicles to move to the preferred location in parallel. The sensors on one vehicle will be used to aid maneuvers of the other vehicles. The multivehicle optimization takes the sensor footprint under consideration to organize the movements and reduce the areas where the vehicles would be performing maneuvers blindly. Multivehicle world model representation is performed where sensor suites from all vehicles are used to create a common representation. The operator aids are migrated to select the pose of the assembled convoy and an optimization algorithm is migrated to solve the multivehicle trajectory generation that deconflicts collisions, simultaneously moves all autonomous vehicles to the desired pose, and optimizes sensor placement where the autonomous vehicles help each other into position.

### 2. Description of Related Art

The statements in this section merely provide background information related to the present disclosure and may not constitute prior art.

There have been no reports in the patent literature related to the development of a system for arranging a number of autonomous vehicles at a staging area comprising two or more autonomous vehicles, a localization mechanism that provides the relative or absolute position of the vehicle to be arranged, a pattern for aligning the vehicles at the staging area and a planning algorithm that can take as input the current state of the vehicles and create obstacle free trajectories that optimize the motion from this current state to a formation that matches the desired pattern. There have also been no reports on the development of operator aids for automated convoy assembly as well as multivehicle deconfliction.

There has been an electro-optical and microcomputer-based method and apparatus for automatically guiding tractors and other farm machinery for the purpose of automatic crop planting, tending, and harvesting. A target is located in one boundary of the field and serves as a reference and the position of the machinery in the field is determined by electro-optically sensing the target with a sensor located on the machinery. A particular trajectory is determined, and the machinery is steered automatically along this trajectory. This method and apparatus are discussed in U.S. Pat. No. 4,769,700.

Remote vehicle missions and systems for supporting remote vehicle missions have been developed. This has an operator control unit having a user interface that allows a user to control the remote vehicle as shown in U.S. Pat. No. 9,104,202.

An unmanned, towable air vehicle has been developed which includes electronic sensors to increase the detection range relative to the horizon detection limitations of a surface craft, an autogyro assembly to provide lift, and a controller to control the operation of the autogyro assembly for unmanned flight. This type of air vehicle is described in U.S. Pat. No. 9,187,173.

No reports have been found in the patent literature in which operator aids are developed for automated convoy assembly as well as multivehicle deconfliction. In addition, there has not been a system developed for arranging a number of autonomous vehicles at a staging area comprising two or more autonomous vehicles, a localization mechanism that provides the relative or absolute position of the vehicle to be arranged, a pattern for aligning the vehicles at the staging area, and a planning algorithm that can take as input the current state of the vehicles and create obstacle free trajectories that optimize the motion from this current state to a formation that matches the desired pattern.

### SUMMARY OF THE INVENTION

The present invention involves the development of a system for arranging a number of autonomous vehicles at a staging area that is composed of two or more autonomous vehicles, a localization mechanism that provides the relative or absolute position of the vehicle to be arranged, a pattern for aligning the vehicles at the staging area, and a planning algorithm that can take as input the current state of the vehicles and create obstacle free trajectories that optimize the motion from this current state to a formation that matches the desired pattern. The invention also involves the creation of a set of operator aids for automated convoy assembly in tactical assembly area. These aids can be remote and do not have to be in the same cab of the vehicle. These aids are used in conjunction with full automation.

Multivehicle deconfliction allows for all vehicles to move to the desired location in parallel and the sensor in one vehicle will be used to aid the maneuvers of other vehicles. It also reduces the areas where the vehicles would be performing maneuvers blindly.

The operator aids are migrated to select the pose of the assembled convoy and an optimization algorithm is migrated to solve the multivehicle trajectory generation that deconflicts collisions, simultaneously moves all vehicles to the desired pose, and optimizes sensor placement in which trucks help each other into position.

### BRIEF DESCRIPTION OF THE DRAWINGS

The present invention is described in the detailed description that follows, with reference to the following noted drawings that illustrate non-limiting examples of embodiments of the present invention, and in which like reference numerals represent similar parts throughout the drawings.

FIG. 1—Illustration that shows the current autonomous vehicle positions (100, 101, and 102) and the different trajectories that bring vehicles to the desired state (103, 103, and 105). All of these trajectories occur within an area that is suitable for driving (106).

FIG. 2—Illustration of the autonomous vehicles in the current position (200, 201, and 202) and then entering an intermediate pose (203, 204, 205) for the autonomous vehicle used for fueling purposes in front of fueling stations (206, 207, 208) and finally ending with the final desired pose (209, 210, 211) after the fueling process is completed. The entire process is conducted in an area the is suitable for driving (212).

FIG. 3—Different types of patterns for the autonomous vehicles to form such as the line pattern (300), staggered pattern (301), V-pattern (302), and the inverted V-pattern (303). These patterns are all formed in areas that are suitable for driving.

### DETAILED DESCRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

There has been a system that has been developed for arranging a number of autonomous vehicles in a staging area which is composed of two or more autonomous vehicles, a localization mechanism that provides the relative or absolute position of the autonomous vehicle to be arranged, a pattern for aligning the autonomous vehicles at the staging area, and a planning algorithm that can take as input the current state of the autonomous vehicles and create obstacle free trajectories that optimize the motion from this current state to a formation that matches the desired pattern.

This system involves arranging autonomous vehicles present in a convoy in a staging area and a localization mechanism provides the relative or absolute position of the autonomous vehicle to be arranged. There is also a pattern for aligning the autonomous vehicles at the staging area which could be one or more of the following: the pattern of the desired assembly, order of the autonomous vehicles, desired separation, starting location, ending location, or state of each autonomous vehicle and could also include other possibilities. There is also a planning algorithm which takes input the current state of the autonomous vehicles and creates obstacle free trajectories which optimize the motion from this current state to a formation that matches the desired pattern.

In the system, the pattern for aligning the autonomous vehicles in the staging area could be one or more of the following: the pattern of the desired assembly, order of the autonomous vehicles, desired separation, starting location, ending location, or state of each autonomous vehicle. Other patterns for aligning the autonomous vehicles in the staging area are also possible and is not limited to these patterns.

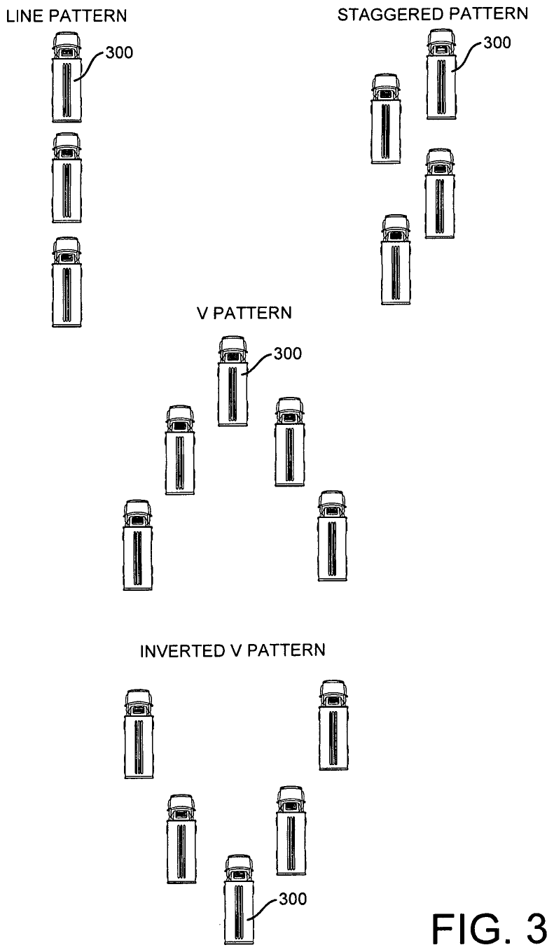

The pattern of the desired assembly could be line shaped, v-shaped, inverted v-shaped, staggered shape, or other shapes and is not limited to these shapes. The different types of patterns for the autonomous vehicles to form such as the line pattern (300), staggered pattern (301), V-pattern (302), and the inverted V-pattern (303) are depicted in FIG. 3.

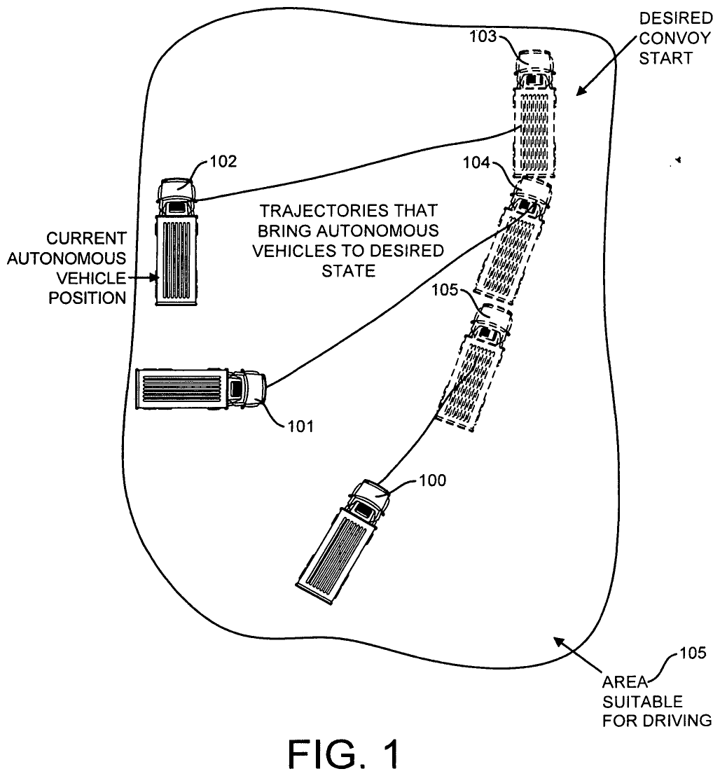

FIG. 1 shows an illustration of the current autonomous vehicle position (100, 101, and 102) and the different trajectories that bring the autonomous vehicles to the desired state (103, 104, and 105). All of these occur within an area that is suitable for driving (106).

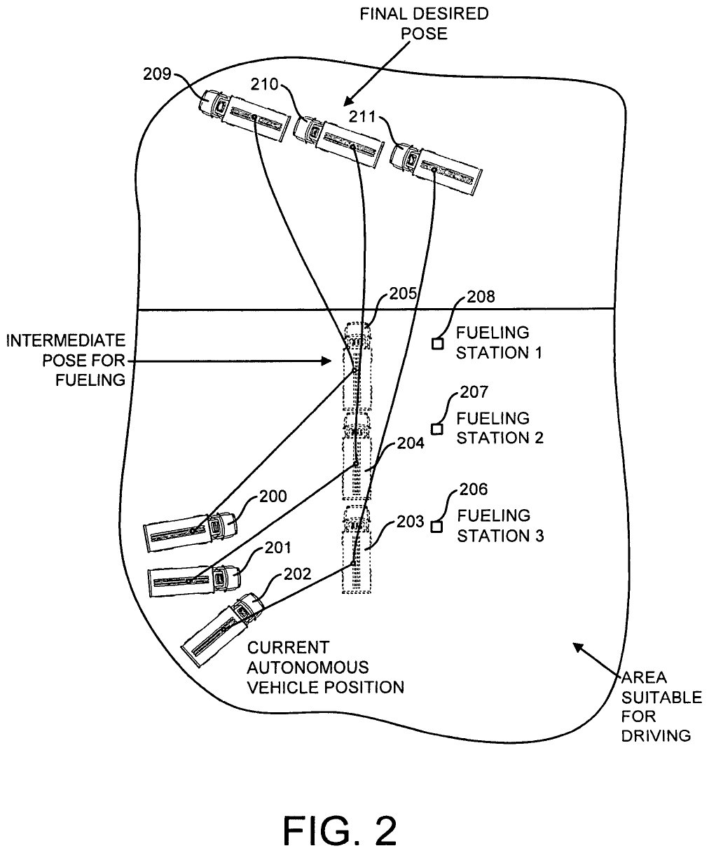

FIG. 2 shows an Illustration of the autonomous vehicles in the current position (200, 201, and 202) and then entering an intermediate pose (203, 204, and 205) for the autonomous vehicle used for fueling purposes when they are located near fueling stations (206, 207, and 208) and finally ending with the final desired pose (209, 210, and 211) after the fueling is completed.

The state of each autonomous vehicle could be different states such as engine on, engine off, electronics on, electronics off, or service brake on or off. Other states of the autonomous vehicles are also possible and are not limited to these.

The optimization is based on one or more of the following: Minimum time, minimum energy consumption, minimizing use of certain roadways or areas, minimizing time at the final position, minimizing wear/tear of vehicles, minimizing risk of collision or flipping. Flipping refers to a type of collision in which the autonomous vehicle turns over completely. The optimization is not limited to only these parameters and can include others too.

The sensors used by the planning algorithm only allows trajectories that are obstacle free and take the autonomous vehicles in areas that are safe that can measure obstacles, pedestrians, and the support surface are located on each vehicle. The sensors are located not only on the autonomous vehicles but also on the yard.

The planning algorithm not only uses the sensors on one vehicle to determine the trajectories, but also uses a global map that includes obstacles and support surfaces fused from all systems in the convoy. The motion of each autonomous vehicle is performed one at a time. Two or more autonomous vehicles go to their assembly area at a time.

The planning algorithm automatically creates intermediate assembly patterns (autonomous vehicles in a line or in a far away area that is not congested) before achieving the final desired state (possibly more congested) in parallel. The autonomous vehicle engines are turned on and off to minimize fuel consumption.

The planner is constantly replanning to account for changes in the yard unrelated to the assembly maneuver. The planner takes under consideration the order at which the autonomous vehicles are ready (being fueled or loaded) before moving them to location. The planner is subdivided into multiple layers. One layer compares the intermediate patterns and desired position of each autonomous vehicle, and a second layer creates trajectories for each individual autonomous vehicle that satisfies/optimizes the commands provided by the upper layer.

The optimization is based on the desired “ready to go time”. The “ready to go time” is the time that the convoy needs to leave, and the planner works backwards to have the autonomous vehicles be ready at that particular time. For example, the convoy needs to leave at XXX time, so the planner will work backwards as to stage the autonomous vehicles to be ready only at time XXX.

The intermediate staging pattern is designed to serve an intermediate need of the convoy, loading gas, cleaning, decontamination, loading cargo, unloading cargo, and other actions. The plans created for each autonomous vehicle are described in position and time for each point of the trajectory. The planner can share these position/time trajectories with other planners assembling other convoys or performing other yard maneuvers.

The convoy contains both manned and unmanned autonomous vehicles. In the case of the manned vehicles, the planner provides a desired pose and time, and possibly a trajectory to follow, which is handed out by an interface on the autonomous vehicle or provided to the yard controller which then relays this information to each manned autonomous vehicle.

There has also been a system developed which comprises a set of operator aids for automated convoy assembly in tactical assembly area. These operator aids do not have to be in the same cab of the autonomous vehicle and can be remote. In addition, the operator aids are used in full automation.

The operator who is in control decides where to form the convoy and where to align and when the operator decides where the convoy is to be placed, the process of positioning the autonomous vehicles to follow the poses provided by the operator is a subset of the tasks necessary to perform alignment of the PLS with the trailer for the loading and unloading maneuvers.

Multivehicle deconfliction is performed which allows all the autonomous vehicles to move to the preferred location in parallel. The sensors of one vehicle will be used to aid the maneuvers of the other vehicles. In addition, the multivehicle optimization takes under consideration the sensor footprint to organize the movements and reduce the areas where the autonomous vehicles would be performing maneuvers blindly.

The multivehicle world model representation is performed where the sensor suites from all autonomous vehicles are used to create a common representation.

The operation aids are migrated to select the pose of the assembled convoy. The optimization algorithm is migrated to solve the multivehicle trajectory generation that deconflicts collisions, simultaneously moves all vehicles to the same pose, and optimizes sensor placement where the autonomous vehicles help each other into their position.

The embodiments of the invention in which an exclusive property or privilege is claimed are defined as follows:

1. A system for arranging a number of autonomous vehicles at a staging area composed of:
two or more autonomous vehicles;
a localization mechanism that provides the relative or absolute position of the autonomous vehicle to be arranged;
a pattern for aligning the autonomous vehicles at the staging area and;
a planning algorithm that can take as input the current state of the autonomous vehicles and create obstacle free trajectories that optimize the motion from this current state to a formation that matches the desired pattern.

2. The system of claim 1 wherein the pattern includes one or more of the following: the pattern of the desired assembly, order of vehicles, desired separation, starting location, ending location, or state of each autonomous vehicle.

3. The system of claim 1 wherein the pattern of the desired assembly includes line shape, v shape, staggered shaped, and other shapes.

4. The system of claim 1 wherein the state of each autonomous vehicle includes engine on, engine off, electronics on, electronics off, or service brake on or off.

5. The system of claim 1 wherein the optimization is based on one or more of the following: minimum time, minimum energy consumption, minimizing use of certain roadways or areas, minimizing time at the final position, minimize wear/tear of vehicles, minimize risk of collision or flipping.

6. The system of claim 1 wherein sensors used by the planning algorithms to only allow trajectories that are obstacle free and take the autonomous vehicles in areas that are safe that can measure obstacles, pedestrians and the support surface are located on each autonomous vehicle.

7. The system on claim 2 wherein the sensors are not only on the autonomous vehicles but also on the yard.

8. The system on claim 2 wherein the planning algorithm not only uses the sensors on one autonomous vehicle to determine the trajectories, but it uses a global map that includes obstacles and support surfaces fused from all systems in the convoy.

9. The system on claim 2 wherein the motion of each autonomous vehicle is performed one at a time.

10. The system on claim 2 wherein two or more autonomous vehicles go to their assembly area at a time.

11. The system on claim 2 wherein the planning algorithm automatically creates intermediate assembly patterns (autonomous vehicles in a line or in a far away area that is not congested) before achieving the final desired state (possibly more congested) in parallel.

12. The system on claim 2 wherein the autonomous vehicles engines are turned on and off to minimize fuel consumption.

13. The system on claim 2 wherein the planner is constantly replanning to account for changes in the yard unrelated to the assembly maneuver.

14. The system on claim 2 wherein the planner takes under consideration the order at which the autonomous vehicles are ready (being fueled or loaded) before moving them to location.

15. The system in claim 2 wherein the planner is subdivided into multiple layers. One layer computes the intermediate patterns and desired position of each vehicle, and a second layer creates trajectories for each individual autonomous vehicle that satisfies/optimizes the commands provided by the upper layer

16. The system on claim 2 wherein the optimization is based on the desired “ready to go time”.

17. The system on claim 2 wherein the intermediate staging pattern is designed to serve an intermediate need of the convoy: loading gas, cleaning, decontamination, loading cargo, unloading cargo, etc.

18. The system on claim 2 wherein the plans created for each autonomous vehicle are described in position and time for each point of the trajectory.

19. The system on claim 14 wherein the planner can share these position/time trajectories with other planners assembling other convoys or performing other yard maneuvers

20. The system on claim 2 wherein the convoy contains both manned and unmanned autonomous vehicles.

21. The system of claim 1 wherein for the manned vehicles, the planner provides a desired pose and time, and possibly a trajectory to follow, which is handed out by an interface on the autonomous vehicle or provided to the yard controller which then relays this information to each manned autonomous vehicle.
